(19) United States
(12) Patent Application Publication
(10) Pub. No.: US 2008/0000972 A1
(43) Pub. Date: Jan. 3, 2008

(54) Roller activation apparatus

(76) Inventors: Wei-Jung Lin, Taipei (TW); Chih-Hsu Tsai, Taipei (TW); Chih-Ching Liao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/478,721

(22) Filed: Jul. 3, 2006

(51) Int. Cl. G06K 7/00; G06K 13/00

(52) U.S. Cl. 235/439; 235/482

(57) ABSTRACT

A roller activation apparatus includes a switch, a roller, a light generator and a light receiver. The roller contacts the switch. A wheel of the roller has at least an opening. A wheel surface of the roller is touched to activate the switch by inputting a card. The roller rotates based on a movement of the card. The light generator is disposed at a side of the roller and is for generating a light beam. The light receiver is disposed at another side of the roller and is for receiving the light beam through the opening of the wheel so as to generate a pulse signal. The pulse signal corresponds to the movement of the card.

### FIELD OF THE INVENTION

The present invention relates to a roller activation apparatus, and more particularly to the roller activation apparatus with power saving.

### BACKGROUND OF THE INVENTION

Currently a sensing card is in widespread use. For instance, a tobacco and beverage vending machine has a sensor to sense a label on a personal identification card of a buyer in order to determine whether the age of the buyer is 18 years of age. However, when the automatic vending machine is not in frequent use, the sensor is still working. The power consumption of the automatic vending machine is increased. The lifetime of the sensor is also decreased. In addition, because the automatic vending machine is operated by the buyer, the velocity for inserting the sensing card may not be controlled that also influences accuracy of the sensor.

The inventor of the present invention based on years of experience on related research and development of the activation apparatuses invents a roller activation apparatus with power saving to overcome the foregoing shortcomings.

### SUMMARY OF THE INVENTION

Accordingly, the object of the present invention is to provide a roller activation apparatus for detecting the velocity of an inputted card. Both power saving and lifetime of the apparatus can be increased.

To achieve the aforesaid object, the roller activation apparatus includes a switch, a roller, a light generator and a light receiver. The roller contacts with the switch. A wheel of the roller has at least one opening. A wheel surface of the roller is touched to activate the switch by inputting a card. The roller rotates based on a movement of the card. The light generator is disposed at a side of the roller for generating a light beam. The light receiver is disposed at another side of the roller. The light receiver is for receiving the light beam through the opening on the wheel to generate a pulse signal. The pulse signal and the movement of the card have a corresponding relationship.

In addition, the present invention further provides a roller activation apparatus for use in a card sensing system. The card sensing system includes a power supply unit, a sensor and a processor. The roller activation apparatus includes a switch, a roller, a light generator and a light receiver. The switch is electrically connected to the power supply unit for controlling the power supply unit. The roller contacts the switch. A wheel of the roller has at least one opening. A wheel surface of the roller is touched to activate the switch by inputting a card. The power supply unit is then controlled to provide a power to the processor and the sensor. The roller rotates based on a movement of the card. The light generator is disposed at a side of the roller for generating a light beam. The light receiver is disposed at another side for receiving the light beam through the opening. The light receiver then generates a pulse signal based on the light beam. The pulse signal and the movement of the card have a corresponding relationship. The light receiver then transmits the pulse signal to the processor. The processor drives the sensor to detect the card based on the pulse signal. Furthermore, when the card is removed from the roller, the switch is turned off to control the power supply unit to stop providing a power.

The roller activation apparatus disclosed by the present invention has the following advantages:
(1) When the card is inputted, the roller activation apparatus controls the power supply unit to provide a power. When the card is removed, the roller activation apparatus controls the power supply unit to stop providing power, thereby achieving goals of increasing power saving and lifetime of components.
(2) The pulse signal generated by the roller activation apparatus and the movement of the card have a corresponding relationship, thereby improving accuracy for detecting the card.

Other features and advantages of the present invention and variations thereof will become apparent from the following description, drawings, and claims.

### BRIEF DESCRIPTION OF THE DRAWINGS

FIG. 1 is a schematic diagram illustrating a roller activation apparatus according to an embodiment of the present invention;

FIG. 2 is a schematic diagram illustrating a roller activation apparatus according to an embodiment of the present invention;

FIG. 3 is a schematic diagram illustrating a pulse signal according to an embodiment of the present invention;

FIG. 4 is a perspective drawing illustrating a roller activation apparatus according to a preferred embodiment of the present invention;

FIG. 5 is a perspective drawing illustrating a roller activation apparatus according to a preferred embodiment of the present invention; and

FIG. 6 is a side elevation illustrating a roller activation apparatus according to a preferred embodiment of the present invention.

### DETAILED DESCRIPTION OF THE PREFERRED EMBODIMENTS

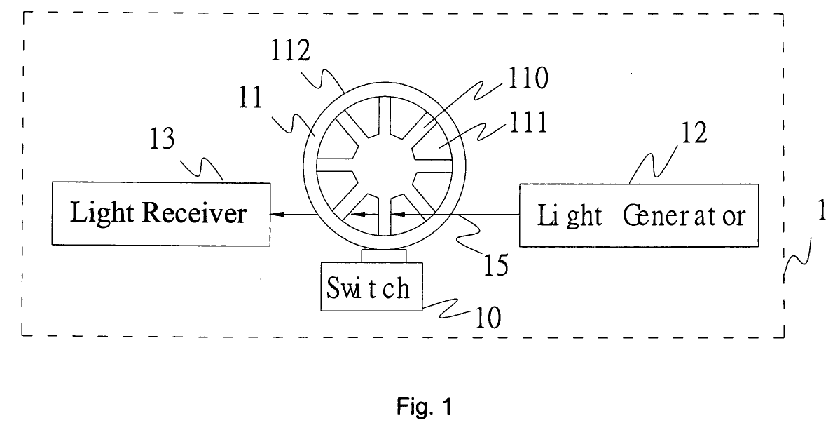

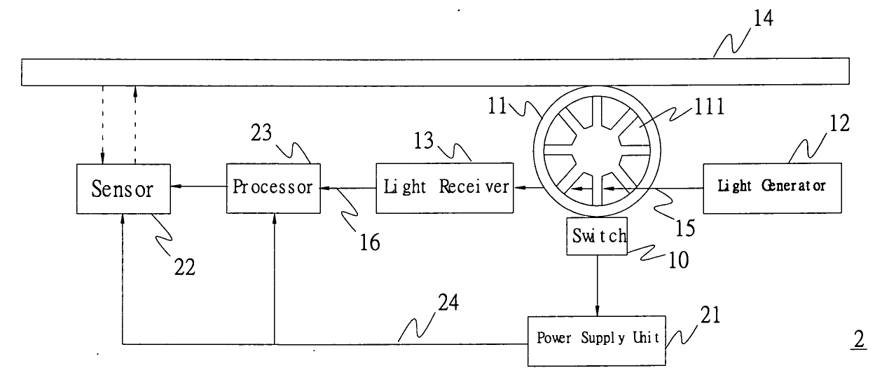

Referring to FIG. 1 and FIG. 2, schematic diagrams illustrate a roller activation apparatus according to embodiments of the present invention. FIG. 2 is a schematic diagram illustrating inputting a card. The roller activation apparatus is applied to a card sensing system. The roller activation apparatus 1 includes a switch 10, a roller 11, a light generator 12 and a light receiver 13. The roller 11 contacts the switch 10. A wheel 110 of the roller 11 has at least one opening 111. A wheel surface 112 of the roller 11 is touched to activate the switch 10 (as shown in FIG. 2) by inputting a card 14 (as shown in FIG. 2). The roller 11 rotates based on a movement of the card 14. The light generator 12 is disposed at a side of the roller 11 for generating a light beam 15. The light receiver 13 is disposed at another side of the roller 11 and receives the light beam 15 through the opening 111 to generate a pulse signal 16. The pulse signal 16 and the movement of the card 14 have a corresponding relationship.

Referring to FIG. 2, the card sensing system 2 includes a roller activation apparatus 1, a power supply unit 21, a sensor 22 and a processor 23. The switch 10 is electrically connected to the power supply unit 21 to control the power supply unit 21. Because the card 14 is inputted to press a wheel of the roller 11, a button of the switch 10 is then forced to control the power supply unit 21 to provide a power 34 for the processor 23 and the sensor 22. The processor 23 is then activated and implements initialization action for the sensor 22. Secondly, the light receiver 13 transmits the pulse signal 16 to the processor 23. The processor 23 drives the sensor 22 to detect the card 14 based on the pulse signal 16. When the card 16 is removed from the roller 11, the roller 11 then stops pressing the switch. The switch 10 is turned off to output a control signal to the processor 23. The power supply unit 21 is then stopped providing the power 24 to the processor 23 and the sensor 22.

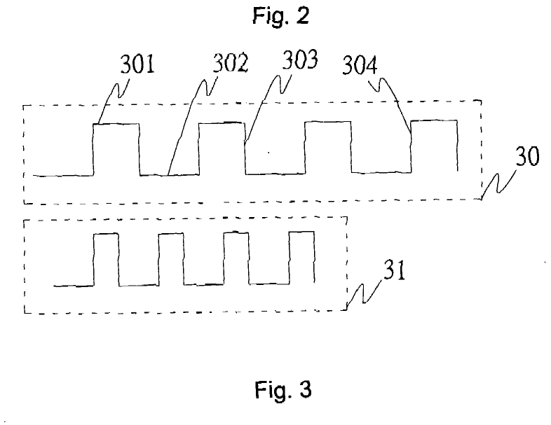

Referring to FIG. 3, a schematic diagram illustrates a pulse signal according to an embodiment of the present invention. The wheel surface 112 of the roller 11 contacts the card 14. When the card 14 moves, the wheel surface 112 of the roller 11 is rubbed with the card 14 to drive the roller 11 to be rotated. Hence, when the roller 11 rotates, the wheel 110 of the roller 11 covers the light beam 15 and the light beam 15 passes through the opening 111 of the wheel 110. The light receiver 22 then receives the light beam 15 intermittently. The light receiver 13 generates a pulse signal 16 based on receiving status. For instance, as shown in FIG. 3, if the light receiver 13 receives the light beam 15, a high potential signal is outputted as a portion 301 of a pulse signal 30. If the light receiver 13 does not receive the light beam 15, a low potential signal is outputted as a portion 302 of the pulse signal 30. The pulse signal 30 has a longer period. The longer period is produced based on a slower movement of the card 15 in the roller activation apparatus 1. The light receiver 13 then generates the pulse signal 16 corresponding to the movement of the card 15. The pulse signal 15 is then transmitted to the processor 23. When the pulse signal 16 is that the high potential signal is toward the low potential signal as a portion 303 of the pulse signal 30, alternatively the low potential signal is toward the high potential signal as a portion 304 of the pulse signal 30, the processor 23 drives the sensor 22 to detect the card 14. Hence, if the period of the pulse signal 16 is shorter, the sensor 22 utilizes faster frequency to detect the card. If the period of the pulse signal 16 is longer, the sensor 22 utilizes slower frequency to detect the card 14. Therefore, no mater how the movement of the card 15 is fast or slow the processor 23 can detect the signal of every relative position for the card 15 accurately based on the pulse signal, thereby achieving goals of recognizing the card and personal identification.

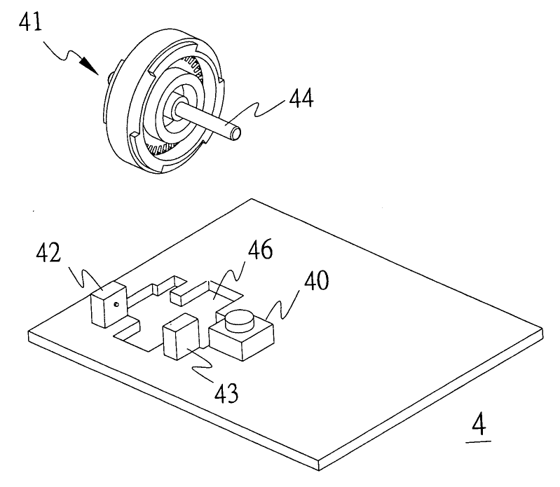

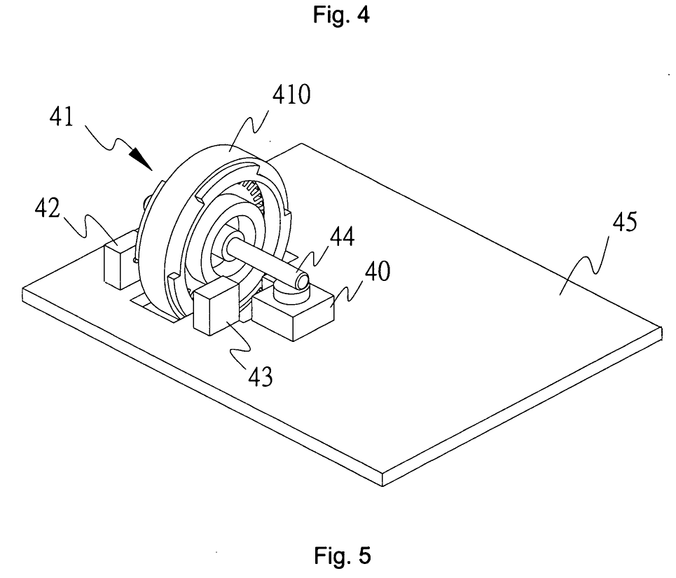

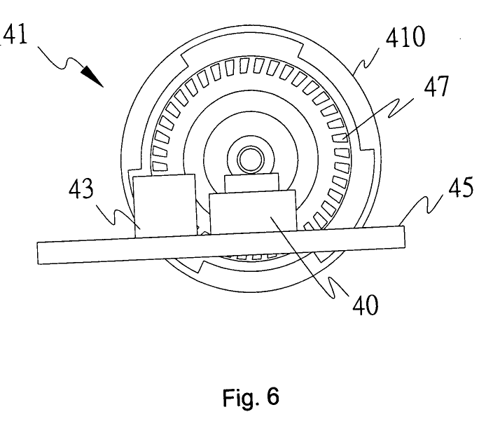

Referring to FIG. 4 to FIG. 6, FIG. 4 and FIG. 5 are perspective drawings illustrating a roller activation apparatus according to preferred embodiments of the present invention. FIG. 6 is a side elevation illustrating a roller activation apparatus according to a preferred embodiment of the present invention. As shown in FIG. 4, the roller activation apparatus 4 includes a switch 40, a roller 41, a light emitting diode (LED) 42 and a phototransistor 43. The roller 41 is disposed in a slot 46 of a substrate 45. As shown in FIG. 5, an axis position of the roller 41 has an extension cylinder 44. The extension cylinder 44 contacts the switch 40. When a wheel surface 410 of the roller 41 is pressed by inputting a card, the extension cylinder 44 then forces a button of the switch 40 to activate the switch 40. When the card is removed from the roller 41, the extension cylinder 44 is stopped forcing the switch 40. The button of the switch 40 returns to an original position to turn off the switch 40. Referring to FIG. 6, the wheel of the roller 41 has at least one opening 47. The phototransistor 43 then receives a light beam emitted by the LED 42 through the opening 47. When the roller 41 rotates, the phototransistor 43 receives the light beam intermittently and generates a pulse signal based on the receiving status.

Although the features and advantages of the embodiments according to the preferred invention are disclosed, it is not limited to the embodiments described above, but encompasses any and all modifications and changes within the spirit and scope of the following claims.

What is claimed is:

1. A roller activation apparatus, comprising:
a switch;
a roller contacted said switch, a wheel of said roller having at least one opening, a wheel surface of said roller being touched to activate said switch by inputting a card, and said roller then rotated based on a movement of said card;
a light generator disposed at a side of said roller for generating a light beam; and
a light receiver disposed at another side of said roller, said light receiver received said light beam through said opening to generate a pulse signal;
wherein said pulse signal and said movement of said card have a corresponding relationship.

2. The roller activation apparatus of claim 1, wherein an axis position of said roller has an extension cylinder for contacting said switch.

3. The roller activation apparatus of claim 1, wherein when said card is removed from said wheel surface of said roller, said switch is turned off.

4. The roller activation apparatus of claim 1, wherein said light generator is a light emitting diode (LED).

5. The roller activation apparatus of claim 1, wherein said light receiver is a phototransistor.

6. The roller activation apparatus of claim 1, wherein when the velocity of said card is slower, the period of said pulse signal is longer.

7. A roller activation apparatus for use in a card sensing system, said card sensing system having a power supply unit, a sensor and a processor, said roller activation apparatus comprising:
a switch electrically connected to said power supply unit for controlling said power supply unit;
a roller contacted said switch, a wheel of said roller having at least one opening, a wheel surface of said roller being touched to activate said switch by inputting a card, said power supply unit being then controlled to provide a power to said processor and said sensor, and said roller then rotated based on a movement of said card;
a light generator disposed at a side of said roller for generating a light beam; and
a light receiver disposed at another side of said roller, said light receiver received said light beam through said opening, a pulse signal being generated based on said light beam, said pulse signal and said movement of said card having a corresponding relationship;
wherein said light receiver transmits said pulse signal to said processor, and said processor then drives said sensor based on said pulse signal in order to detect said card.

8. The roller activation apparatus of claim 7, wherein an axis position of said roller has an extension cylinder for contacting said switch.

9. The roller activation apparatus of claim 7, wherein when said card is removed from said wheel surface of said roller, said switch is turned off.

10. The roller activation apparatus of claim 9, wherein said switch controls said power supply unit to stop providing said power to said processor and said sensor.

11. The roller activation apparatus of claim 7, wherein said light generator is a LED.

12. The roller activation apparatus of claim 7, wherein said light receiver is a phototransistor.

13. The roller activation apparatus of claim 7, wherein when the velocity of said card is slower, the period of said pulse signal is longer.

14. The roller activation apparatus of claim 7, wherein said processor drives said sensor based on a raising edge signal and a falling edge signal of said pulse signal.
